(19) United States
(12) Patent Application Publication
(10) Pub. No.: US 2023/0178114 A1
(43) Pub. Date: Jun. 8, 2023

(54) GENERATING MULTIPLE VERSIONS OF AN AUDIO DIGITAL COMPONENT

(71) Applicant: Google LLC, Mountain View, CA (US)

(72) Inventors: Nathaniel Marc Biggs, Brooklyn, NY (US); Roni Rosner, New York, NY (US); Natalie Marion Bennett, Brooklyn, NY (US); Emily Ryan, London (GB); Ruoxi Mao, Long Island City, NY (US); Yeo Jin Ree, New York, NY (US)

(21) Appl. No.: 17/427,435

(22) PCT Filed: Sep. 10, 2020
(86) PCT No.: PCT/US2020/050124

§ 371 Date: Jul. 30, 2021

(30) Foreign Application Priority Data
Aug. 23, 2020 (IL) 276878

(51) Int. Cl. G11B 27/036; G11B 27/34

(52) U.S. Cl. CPC G11B 27/036; G11B 27/34

(57) ABSTRACT

Methods, systems, and apparatus, including computer programs encoded on a computer storage medium, for generating variants/versions of an audio digital component and providing a particular variant for displaying/playing on a client device. Methods can include receiving a request to generate a template for an audio digital component. Based on information in the request, the template can be generated. A first set of media data items can be linked to static media data blocks in the template. Based on the template, variants of the audio digital component can be generated and for each, media data items can be linked to the dynamic media data blocks. A request for the audio digital component can be received from a client device. A set of signals can be obtained from the client device, based on which, a particular variant of the audio digital component can be provided for display on the device.

### CROSS-REFERENCE TO RELATED APPLICATION

This application is an international application and claims the benefit of Israel Application No. 276878, filed Aug. 23, 2020. The disclosure of the foregoing application is hereby incorporated by reference in its entirety.

### BACKGROUND

This specification generally relates to data processing, and generation of multiple variants/versions of an audio digital component.

A client device can receive digital components from one or more content providers, e.g., via a commercial web browser or through a native application (e.g., a music player application), and provide these received digital components for consumption (e.g., viewing, listening) by the user of the client device. For example, when the digital component is an image, the client device can provide the digital component for display via the client device’s display. As another example, when the digital component is a video, the client device can provide the digital component for display via the client device’s display and play the audio corresponding to the video via the device’s speakers. As yet another example, when the digital component is an audio, the client device can play the audio corresponding to the video via the device’s speakers.

Such audio digital component may include multiple types of audio elements such as voice, music, and/or sound effects. For example, an audio digital component may include one or more voice elements (e.g., a person speaking, an entity uttering words), one or more music elements (e.g., background music or another score), and/or one or more sound effects elements (a sound other speech or music, e.g., a buzzer sound, the sound of a car screeching to a stop, etc.). In some instances, such audio digital components may also include a companion image that is displayed while the audio content is being played.

### SUMMARY

In general, one innovative aspect of the subject matter described in this specification can be embodied in methods including the operations can include receiving, via a user interface, a request to generate a template for an audio digital component, the request including a set of data, wherein the set of data includes data specifying media data blocks for inclusion in the audio digital component, wherein each media data block (1) is a container for a media data item and (2) is of a particular media type; determining, based on the set of data included in the request and for each media data block, whether the media data block includes static or dynamic content, wherein a media data block includes (1) static content when a media data item linked to the media data block remains unchanged in variants of the audio digital component or (2) dynamic content when a media data item linked to the media data block changes in one or more variants of the audio digital component; in response to receiving the request and determining whether the media data blocks include static or dynamic content, generating the template for the audio digital component; linking a first set of media data items to media data blocks in the template that are identified as including static content; generating, based on the template, a plurality of variants of the audio digital component, including, for each variant, automatically linking the first set of media data items with media data blocks in the variant that are identified as including static content; for each variant of the audio digital component, linking a second set of media data items to media data blocks in the variant that are identified as including dynamic content; receiving, from a client device, a request for the audio digital component; obtaining a set of signals representing a context within which the request for the audio digital component is made by the client device; and providing for display, to the client device and based on the set of signals representing the context, a particular variant of the audio digital component from among the plurality of variants. Other embodiments of this aspect include corresponding methods, apparatus, and computer programs, configured to perform the actions of the methods, encoded on computer storage devices. These and other embodiments can each optionally include one or more of the following features.

In some implementations, methods can further include wherein the user interface is a configurable user interface.

In some implementations, methods can further include detecting, via the configurable user interface, configurations by a user to a base template; wherein receiving the request to generate the template for the audio digital component that specifies the set of data comprises: in response to detecting the configurations by the user to the base template, receiving the request to generate the template for the audio digital component, wherein data included in the request is based on the configurations by the user.

In some implementations, methods can further include receiving, via the user interface and for each variant among the plurality of variants, a set of rules that define conditions specifying when the variant is to be provided for display to a requesting client device.

In some implementations, methods can further include providing for display, to the client device and based on an evaluation of the set of signals and each set of rules, a particular variant of the audio digital component, including: determining whether the set of signals match any of the sets of rules corresponding to the plurality of variants; and in response to determining that the set of signals match a particular set of rules corresponding to a particular variant, providing the particular variant for display to the client device.

In some implementations, the set of rules can specify one or more of the following: a location of the requesting the client device; weather at the location of the requesting the client device; a date when the request for the audio digital component was received; a time when the request for the audio digital component was received; or a genre of music previously played by the client device.

In some implementations, methods can further include receiving modifications to the template for the audio digital components, wherein the modifications are generated based on interactions with the configurable user interface, wherein the interactions specify one or more of the following: a change to the total duration of the audio digital component; an addition of a media data block to be played after a time interval when another media data block is scheduled to cease playing or being displayed; a special effect to add to a media data item provided within a media data block; an adjustment to the time interval during which a media item for a respective media data block is to be played or displayed; a change to the identification that specifies whether the media data block includes static content or dynamic content; or a replacement of a media data item associated with a media data block with another media data item.

In some implementations, methods can further include obtaining, via the user interface, the first set of media data items and each of the second set of media data items, including: receiving a request to upload media data items via a batch upload operation; providing a user interface for performing the batch upload operation; and receiving, via the user interface for performing the batch upload operation, a batch file that (1) identifies the media data items, (2) identifies resource locations of the media data items, and (3) includes a mapping between each media data item and a respective media data block in the plurality of variants.

In some implementations, the set of data further can include: a total duration of the audio digital component; and a time interval in the total duration specifying when a media data item for each respective media data block is to be played or displayed.

Particular embodiments of the subject matter described in this specification can be implemented to realize one or more of the following advantages.

The techniques described in this specification use a template-based approach in generating multiple versions/variations of an audio digital component, which results in significant savings in computing resources. For example, the techniques described in this specification can generate a template that specifies the types of content and the attributes of the content to be included in the template. Once the template is generated, the techniques described herein can generate multiple versions/variants of the template in which certain content (e.g., content that is expected to be common across all versions of the template) is automatically replicated—i.e., without needing separate configurations for each variant. This template-based replication technique saves computing resources that would otherwise be required to receive the content and the respective attributes for each variant, and to use this received information to generate each variant. The described techniques therefore enable more efficient generation of audio digital components. This is particularly important where large numbers of variants of audio digital components are generated. For example, bandwidth requirements may be reduced through avoiding the need to transmit content for each individual variant. Moreover, battery and processor requirements may be reduced through avoiding the need to process and manipulate all of the content in each individual variant. For n variants, instead of generating all features of the n variants independently, the described techniques harness a template in which content that is common across all variants is automatically replicated. This provides a considerable reduction in the computational resources that are required and therefore more efficient generation of audio digital components at scale. In addition, all of the variants may be generated in a same platform and/or generated in a single process and/or distributed as a single item of content to serve based on specific dynamic rules, which may lower bandwidth requirements associated with transferring content backwards and forwards between different entities. Moreover, bulk or batch upload of media data items to be used in the plurality of variants further reduces bandwidth requirements, for example by reducing computational overheads associated with transmitting individual media data items.

Moreover, this template-based technique also saves computer storage resources. This is because, rather than having to store multiple sets of substantially the same content/media data items (i.e., content for the static data blocks in each variant that will be the same for each variant), the techniques described herein only store a single, unique set of media data items for the various variants. The described techniques therefore enable more efficient storage of audio digital components. This is particularly important where large numbers of variants of audio digital components are generated. For n variants, instead of storing n copies of, for example, a backing track, the described techniques enable a single copy of the backing track to be stored, which can be automatically linked to in each variant. This provides a considerable reduction in the computational storage that is required and therefore more efficient storage of audio digital components at scale.

Further still, the techniques described in this specification also enable resourceefficient modification of the multiple variants of the audio digital component compared to other techniques. For example, other techniques may combine the various types of media (e.g., voice, background music, sound effects) included in an audio digital component into a single data stream. When generating multiple versions of such an audio digital component, such techniques generally require parsing the combined audio data stream, identifying portions of the stream to alter and replace with new content, and processing the stream to replace the content without affecting the fidelity of other content also being played/displayed during the same time interval. This process can consume a significant amount of time and/or computing resources, which may often be outweighed by the time and resources otherwise required to generate a new version of the audio digital component (as opposed to modifying an existing version of the audio digital component). In contrast, the techniques described herein use a modular approach that requires discretely specifying the various media data blocks corresponding to each separate type of media (e.g., sound effects, voice, music) and then linking a media item (of the same type) to each of these media data blocks. As a result, for each variant of the audio digital component, swapping out/replacing/adding a media data item only requires linking a new content/media data item with a particular media data block, which thus requires significantly fewer resources in comparison to modifying an existing audio stream or generating a new audio digital component. In other words, replacing or adding media data items to each variant of the audio digital component does not require any complex audio data stream parsing, separation, and/or processing.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital content is distributed and provided for display on client devices.

FIGS. 2A-2H are example user interfaces that show various configurations that can be made via the template and variants interfaces (as referenced in FIG. 1).

FIG. 3 is a flow diagram of an example process for generating and distributing variants of an audio digital component based on a template generated for the audio digital component.

FIG. 4 is a block diagram of an example computer system that can be used to perform operations described.

### DETAILED DESCRIPTION

This specification generally relates to efficient generation of multiple variants/iterations of a particular audio digital component and providing a particular variant for displaying/playing based on the context within which the request for content/audio digital component was made.

As summarized below and described in greater detail throughout this document, a template generator generates a template for an audio digital component, a variant manager generates multiple variants/versions of the audio digital component based on the generated template, and a rules engine provides a particular version/variant of the audio digital component from among the multiple generated variants, for display in response to a request for content from a client device.

The template generator receives, via configurations/interactions by a user on a user interface, a request to generate a template for an audio digital component. This request includes a set of data, e.g., specifying (1) media data blocks for inclusion in the audio digital component, (2) whether each media data block includes static or dynamic content, (3) a total duration for the audio digital component, and (4) a time interval during which content corresponding to each media data block is to be played/displayed. As used in this specification, a media data block is a container for a media data item (a particular content item that includes media) and is of a particular media type (e.g., voice, sound effects, image, or music). In other words, a media data block is a pre-allotted data block to which a particular media data of a particular media type can be linked. As used in this specification, a media data block includes static content when a media data item linked to the media block remains unchanged in variants of the audio digital component and a media data block includes dynamic content when a media item linked to the media block changes in one or more variants of the audio digital component.

Based on this request and the set of data included in the request, the template generator determines the attributes to be included in the template for the audio digital component. For example, based on the set of data, the template generator determines the media data blocks to be included in the template, whether the media data blocks include static or dynamic content, the duration of the audio digital component, and the time interval during which the content corresponding to each media data block is to be played or presented. Based on these attributes, the template generator generates the template for the audio digital component. The template generator also links a first set of media items to media data blocks in the template that are identified as including static content.

Using the generated template, the variant manager generates multiple copies of the audio digital component, which are referred to as variants or versions of the audio digital component. For each variant, the variant manager automatically links the first set of media items with media data blocks in the variant that are identified as including static content (as already defined in the template generated by the template generator). In this manner, there is no need to separately link the same content for the common media data blocks (and the corresponding attributes) for every variant. In addition, for each variant, the variant manager also links a second set of media data items to media data blocks identified as including dynamic content. The second set of media data items for the dynamic media data blocks of each variant can be different. For example, a media data item for one dynamic media data block in one variant may be different from another media data item for the same dynamic media data block in another variant.

Subsequently, when a request for the audio digital component is received from a client device, the rules engine obtains a set of signals representing the context within which the request is made by the client device. The rules engine compares the set of signals representing the context with a set of rules for each variant. If a match is found, the rules engine determines that the variant corresponding to the matching set of rules is to be provided for display on the client device. The rules engine provides the determined variant for display on the requesting client device.

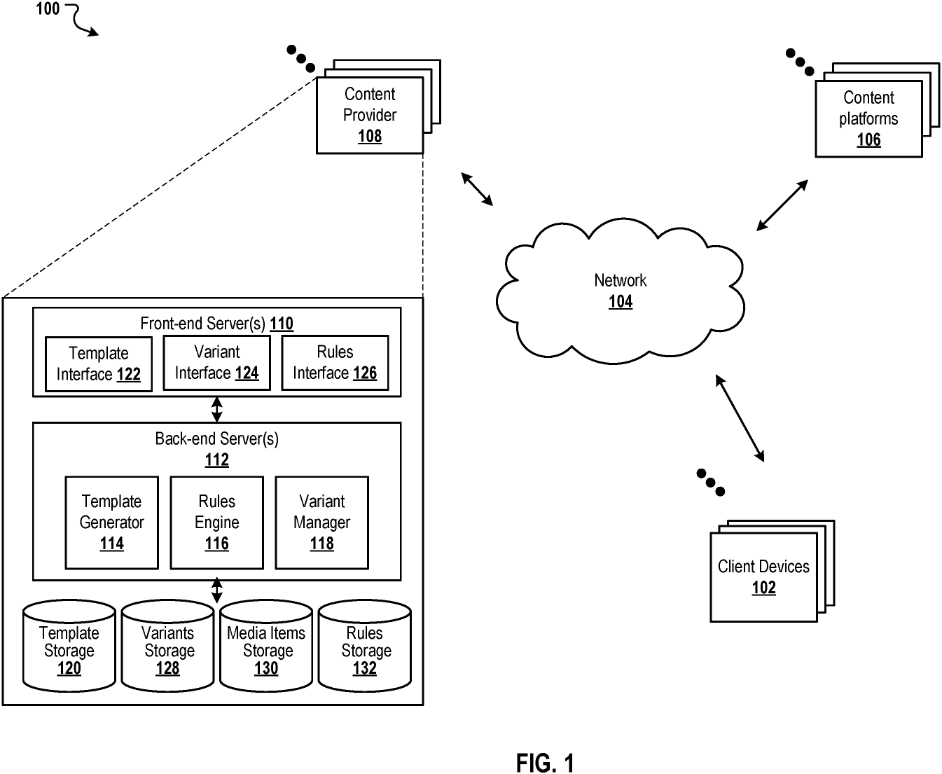

These features and additional features are further described below with reference to FIGS. 1-4.

FIG. 1 is a block diagram of an example environment 100 in which digital content is distributed and provided for display on client devices.

The example environment 100 includes a network 104. The network 104 can include a local area network (LAN), a wide area network (WAN), the Internet, or a combination thereof. The network 104 can also include any type of wired and/or wireless network, satellite networks, cable networks, Wi-Fi networks, mobile communications networks (e.g., 3G, 4G, and so forth), or any combination thereof. The network 104 can utilize communications protocols, including packet-based and/or datagram-based protocols such as internet protocol (IP), transmission control protocol (TCP), user datagram protocol (UDP), or other types of protocols. The network 104 can further include a number of devices that facilitate network communications and/or form a hardware basis for the networks, such as switches, routers, gateways, access points, firewalls, base stations, repeaters or a combination thereof.

The network 104 connects client devices 102, content providers 108, and content platforms 106. The example environment 100 may include many different content platforms 106, content providers 108, and client devices 102.

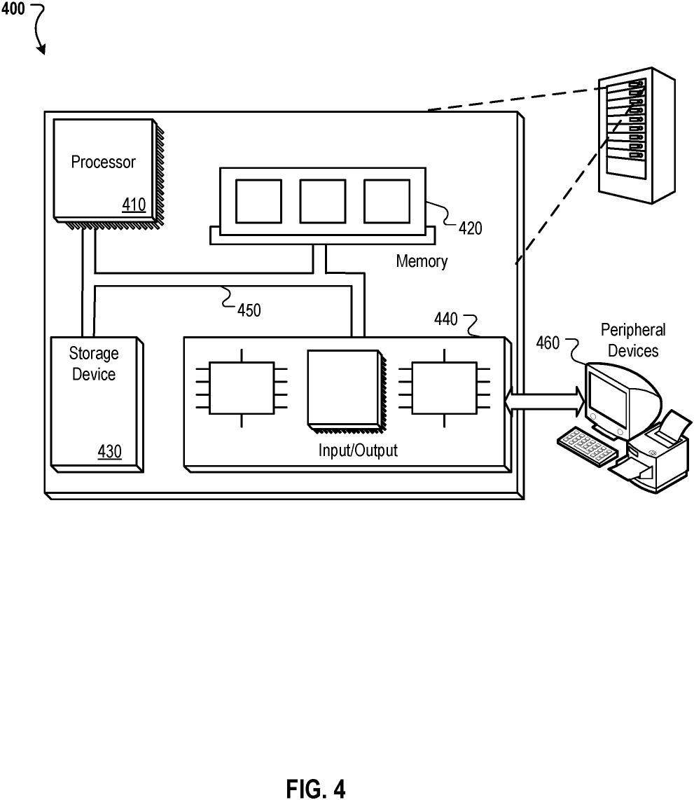

A content platform 106 is a computing platform (such as, e.g., a data processing apparatus described with reference to FIG. 4) that enables distribution of content. Example content platforms 106 include search engines, social media platforms, new platforms, data aggregator platforms, or other content sharing platforms. Each content platform 106 may be operated by a content platform service provider.

The content platform 106 can publish and make available its own content. For example, the content platform 106 may be a news platform, which publishes its own news articles. The content platform 106 may also present content provided by one or more content providers 108 that are not part of the content platform 106. In the above example, the news platform may also present third party content provided by one or more content providers 108. As another example, the content platform 106 may be a data aggregator platform that does not publish any of its own content, but aggregates and presents third party content provided by different content providers 108.

A content provider 108 is a computing platform (such as, e.g., a data processing apparatus described with reference to FIG. 4) and can include servers, repositories, or other storage devices that store content generated and/or published by one or more entities and that provide content to content platforms 106 and/or client devices 102 in response to requests for content from these entities.

A client device 102 is an electronic device that is capable of requesting and receiving content over the network 104. Example client devices 102 include personal computers, mobile communication devices, digital assistant devices, and other devices that can send and receive data over the network 104.

An example client device 102 typically comprises an operating system that is primarily responsible for managing the device hardware such as device storage and software resources, such as applications. The client device 102 typically includes applications, such as, e.g., a web browser or a native application, to facilitate the sending or receiving of data over the network 104 and presenting/producing content (e.g., content pages, music, videos, etc.) for consumption on the client device 102.

In some implementations, a content provider 106 can enable a content creator to generate digital components (e.g., audio digital components) and make them directly available for distribution via the content provider 106. In such implementations, the content provider 106 can include one or more front-end user servers 110, one or more back-end servers 112, and one or more storage devices (such as, e.g., storage devices 120, 128, 130, and 132). Each of the storage devices can include one or more databases (or other appropriate data storage structures) stored in one or more non-transitory data storage media (e.g., hard drive(s), flash memory, etc.).

The front-end servers 110 can transmit data to, and receive data from, client devices 102 over the network 104. For example, the front-end servers 110 can provide, to an application executing on a client device 102, interfaces (e.g., the template interface 122, the variant interface 124, or the rules interface 126) or data for presentation with the interfaces. The front-end servers 110 can also receive a set of data specifying user interactions with/configurations on one or more of these (and/or other) interfaces, which can include, e.g., data for generating a template of the audio digital component and/or data for each variant/actual copy/iteration of the audio digital component (as further described below).

The front-end servers 110 can also communicate with the back-end servers 112. For example, the front-end servers 110 can identify data that is to be processed by the back-end servers 112, e.g., data for generating a template of the audio digital component and/or data generating and managing each variant of the audio digital component (as further described below), and provide the identified data to the back-end servers 112.

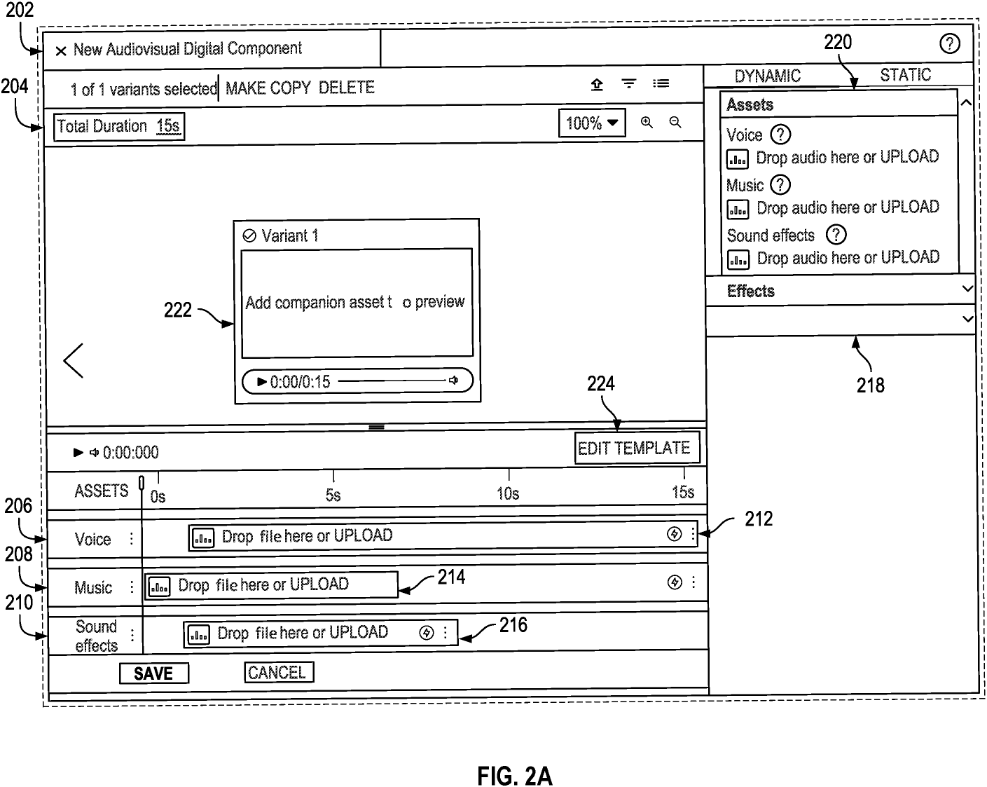

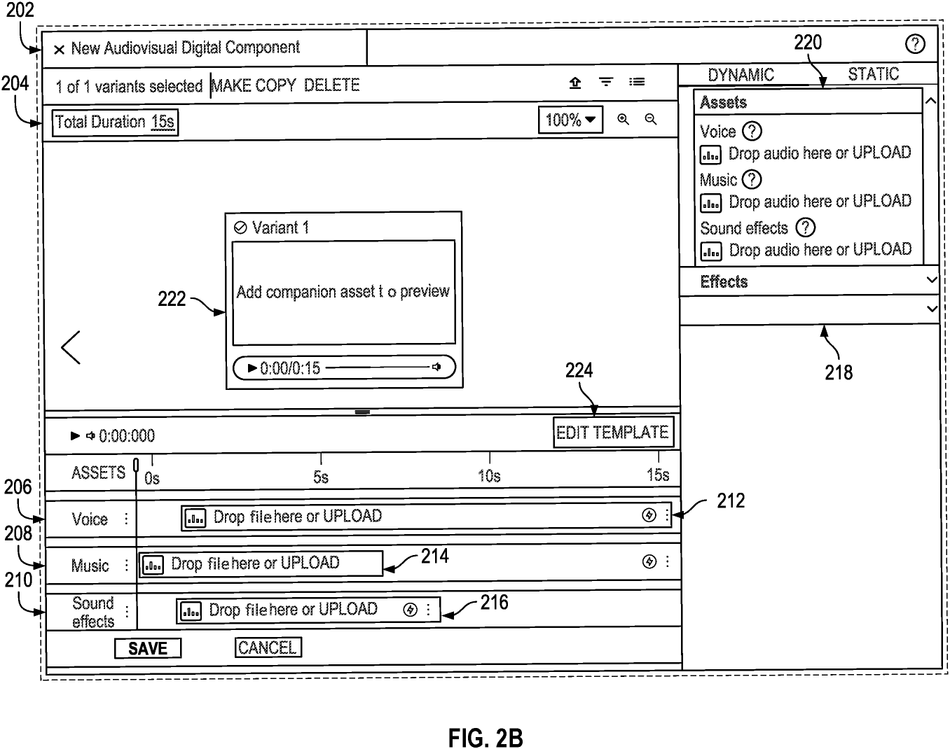

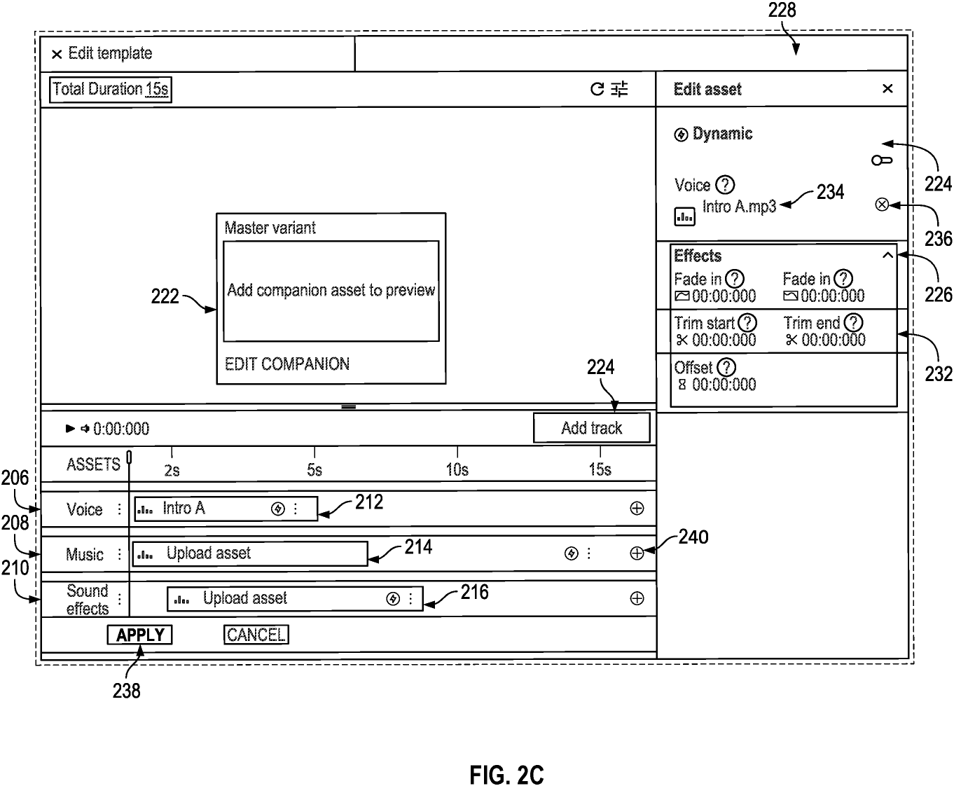

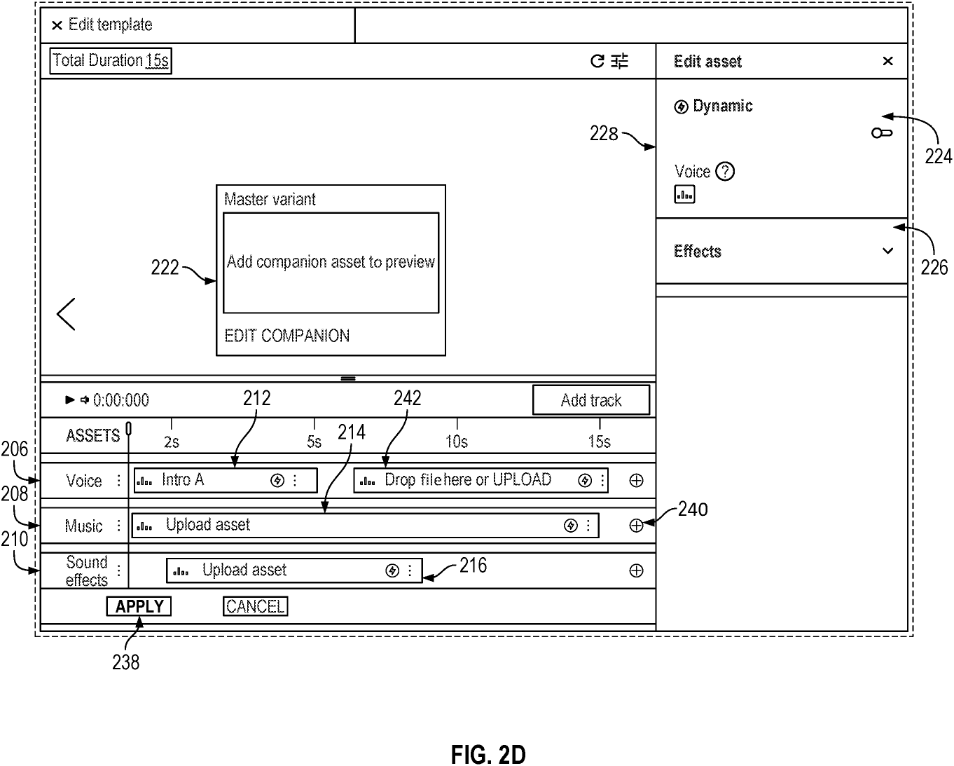

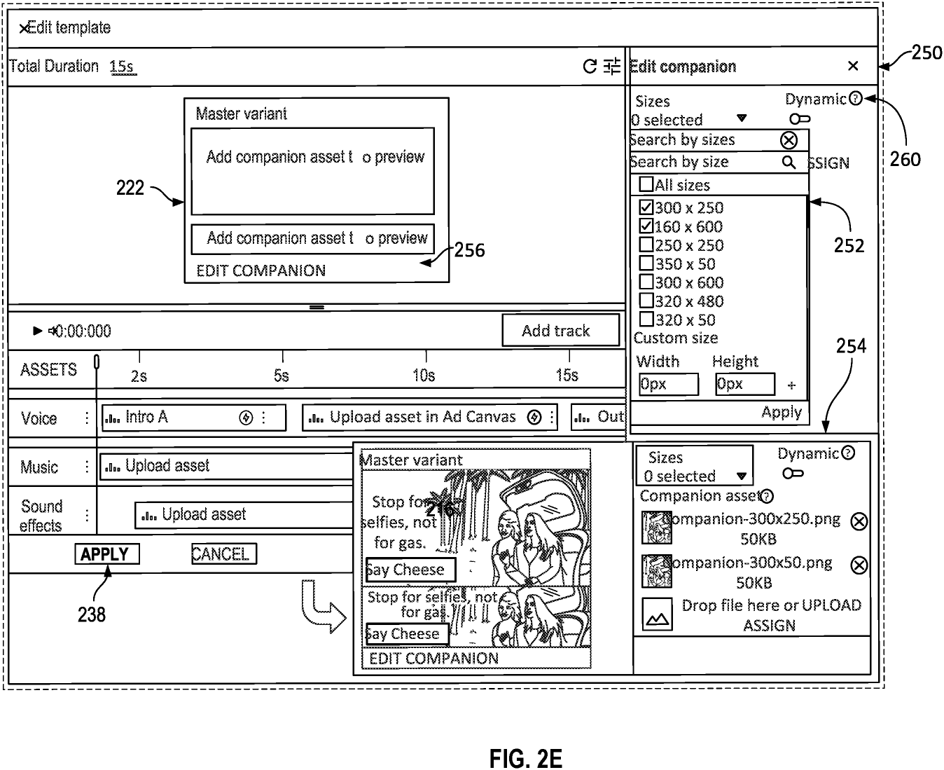

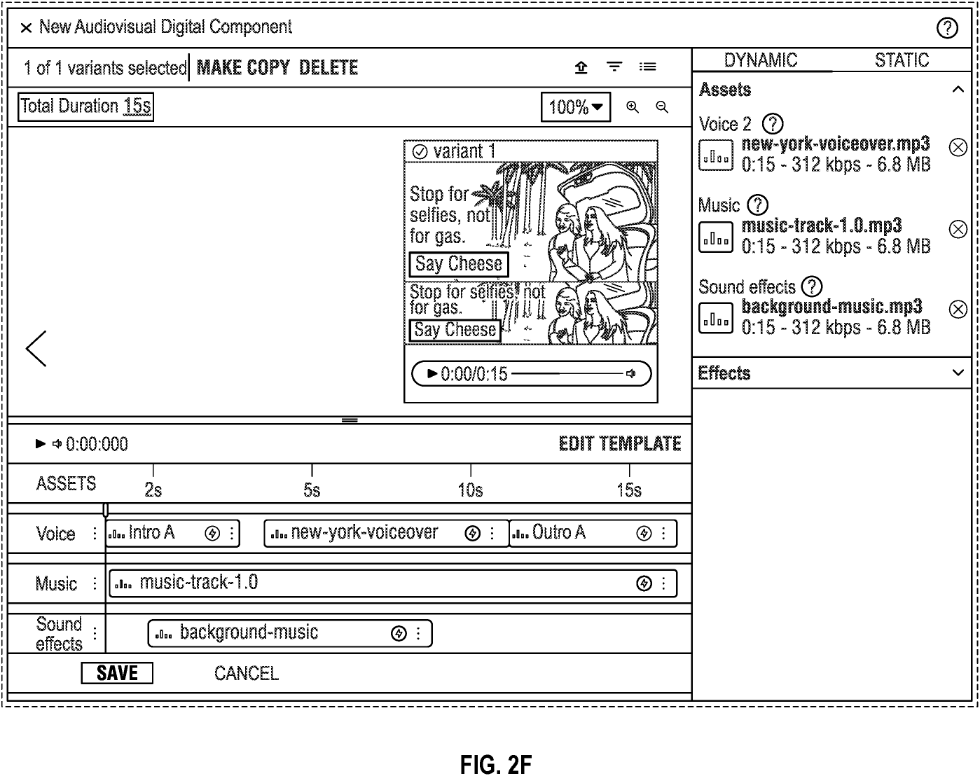

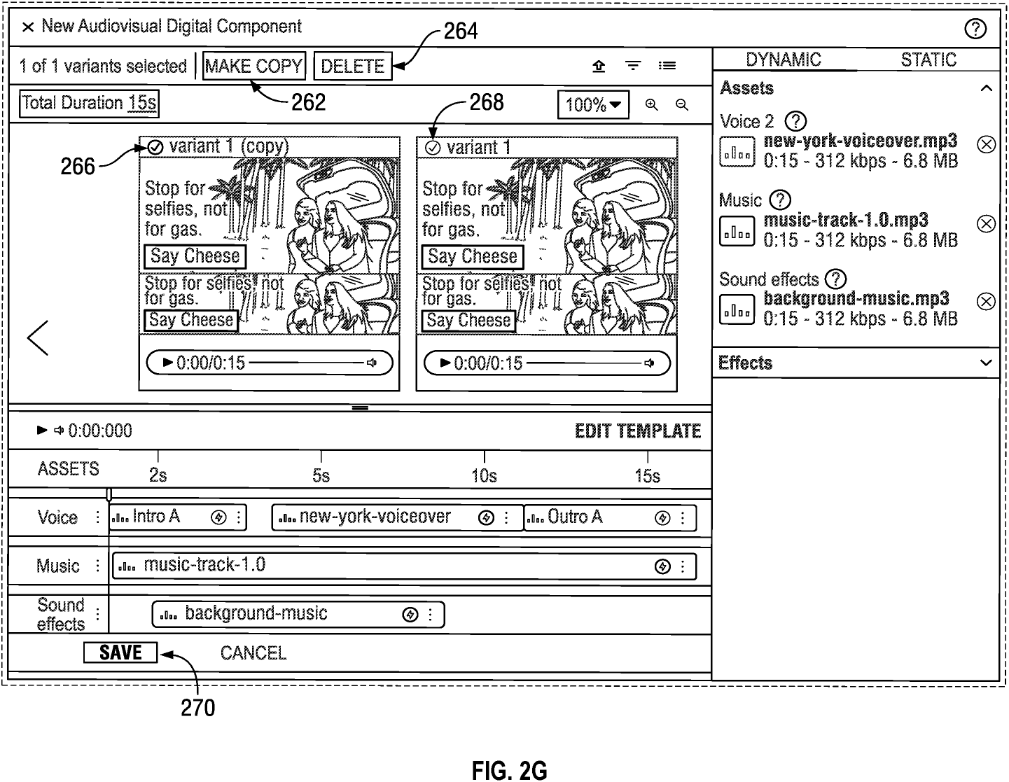

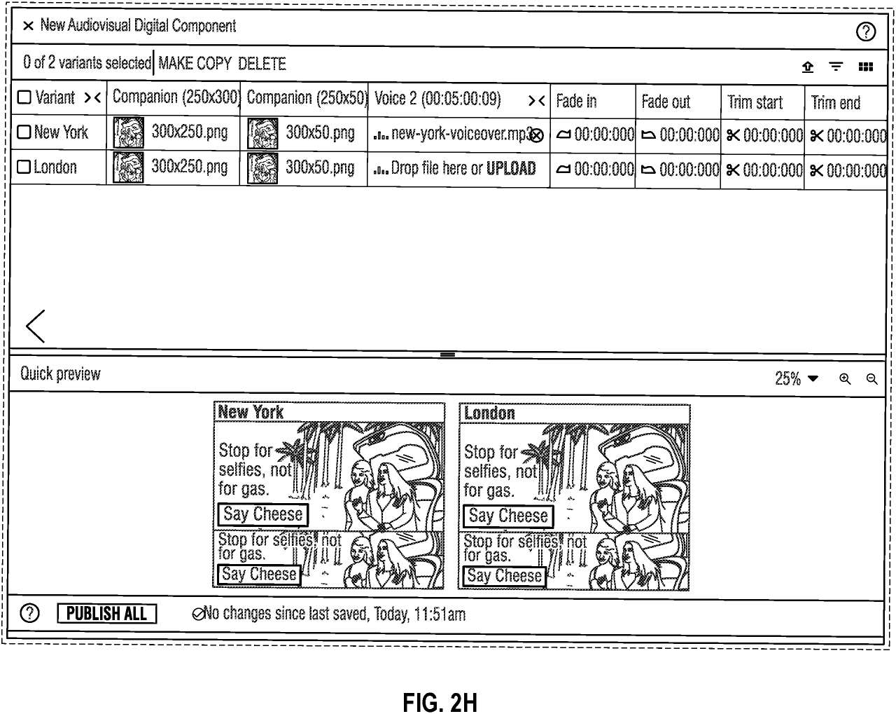

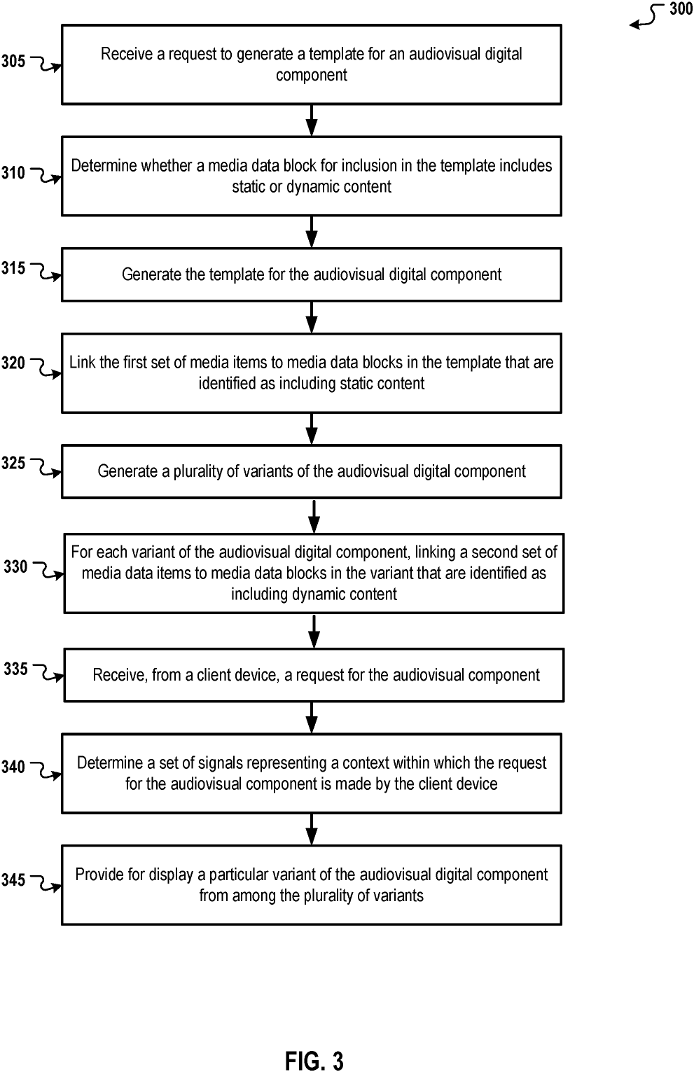

The back-end servers 112 can include a template generator 114, a rules engine 116, and variant manager 118. Each of these components of the back-end servers 112 can be implemented as a data processing apparatus (as described with reference to FIG. 4) that performs a set of tasks. The operations/tasks performed by each of these components is summarized below, and described in greater detail with reference to FIGS. 2 and 3.

The template generator 114 generates templates for an audio digital component. The template generator 114 provides a base template for display and further configuration in the template interface 122. The template generator 114 receives a set of data (also referred to as user-specified configuration data) based on interactions/modifications to the base template, via the template interface 122. This set of data can include data specifying, e.g., a total duration of the audio digital component, a number of media data blocks to include in the template, the time intervals during the duration of the audio digital components when the media data item linked to a respective media data block will be played/presented, the types of media (such as audio, voice, sound effects, images) to be linked to the media data blocks, whether the media data block includes static or dynamic content, and/or the media data items to be linked to, e.g., static media data blocks.

Using the received user-specified configuration data, the template generator 114 generates the template for the audio digital component. The generated template can be a data file or a configuration file that serves as a blueprint of the blueprint of the audio digital components and specifies the various media data blocks, their respective attributes (time intervals, special effects, duration, etc.), and the relationships between these blocks, to be included in each variant/copy of the audio digital component. The template generator 114 can store the template for the audio digital component in the template storage device 120.

The variant manager 118 generates and manages variants/copies of the audio digital component using the template for the audio digital component. The variant manager 118 provides a variant interface 124 within which an operator of the content creator can indicate that multiple copies of the template for the audio digital component need to be made, and provide configurations for the actual iterations of the audio digital component, such as the media items to link to, e.g., each dynamic media data block in each variant (as described further in FIGS. 2 and 3). Using these configurations and based on the generated template, the variant manager 118 generates multiple copies/variants of the template and updates each copy of the template based on the specified configurations (e.g., by linking, for each variant, media items to the respective media blocks specified in the configurations). The variant manager 118 provides the various variants for storage in the variants storage device 128. In this manner, the variant manager 118 can quickly and efficiently generate multiple copies/variants of the same audio digital component.

The media items linked to the various media data blocks in the template and/or the various variants (e.g., by the template generator 114 and the variants manager 118) are stored in the media items storage device 130. In some implementations, the media items storage device only stores a single copy of each unique media data item regardless of whether a media data item is used in multiple variants (e.g., a static media item that is common across/included in each variant), thus avoiding redundant storage of media data items. In some implementations, the templates and variants stored in the template storage device 120 and the variants storage device 128, respectively, do not also store the media items linked to the various media data blocks (specified in the template and the variants). This further reduces redundant storage of media items for each variant.

The rules engine 116 determines, using a set of rules, a particular variant of the audio digital component from among the multiple variants generated by the variant manager 118, to provide to a client device requesting the audio digital component. The rules engine 116 receives user configurations/interactions on a rules interface 126 that specifies conditions under which each variant is to be provided to a requesting client device. Using these user configuration/interactions, the rules engine 116 generates, for each variant, a set of rules specifying the conditions under which each variant is to be provided to a requesting client device. The rules engine 116 stores each set of rules corresponding to a respective variant in the rules storage device 132. Subsequently, when the content provider 108 receives, from a client device 102, a request for content and in particular a request for the audio digital component, the rules engine 116 uses the various sets of rules in determining the appropriate variant of the audio digital component to provide to the client device 102 (as further described with reference to FIG. 3). The rules engine 116 then provides the determined variant and the corresponding set of media items (from the media items storage device 130) for display on the requesting client device 102.

FIGS. 2A-2G are example user interfaces that show various configurations that can be made via the template and variants interfaces, which are used to specify how to generate a template for an audio digital component and its corresponding variants. Each of these figures is described in turn below.

FIG. 2A shows an example base template that could be provided in an example template interface 122.

Item 202 specifies the name of the audio digital component that an operator can modify by interacting with that field. Item 204 specifies the total duration (e.g., play time of the audio digital component). The total duration field is currently shown as 15 seconds. The bottom of FIG. 2A shows three swim lanes (206, 208, 210), each corresponding to a particular media type. In particular, swim lanes 206, 208, and 210 correspond to media types “voice,” “music,” and “sounds effects,” respectively.

The length of the swim lanes corresponds to the length of time (total duration) of the audio digital component. In this example, each swim lane spans from a time of zero seconds to fifteen seconds (which is the currently specified total duration of the audio digital component).

Each media type swim lane also includes a respective media data block (212, 214, 216), each of which is also referred to as an asset. Because the swim lane 212 corresponds to the voice media type, all media blocks in this swim lane would be of the voice media type. Similarly, because the swim lane 214 corresponds to the music media type, all media blocks in these respective swim lanes would be of the music media type. Similarly, because the swim lane 216 corresponds to the sound effects media type, all media blocks in these respective swim lanes would be of the sound effects media type. The media blocks shown in the swim lanes are collectively referred to as assets.

The right panel 218 of FIG. 2 shows a subpanel 220 that lists the assets/media data blocks included in the swim lanes 206-210. For each listed asset, a user can upload an actual voice, music, or sound effect file to the corresponding block of the same media type. The operator can perform this upload operation by, e.g., dragging and dropping the file from a storage location (e.g., a storage location on the operator’s device or some other storage location, such as a cloud or networked storage location) into this panel. Alternatively, the operator can perform the upload operation by clicking the UPLOAD link that launches a file explorer from the operator enabling navigation to a storage location (e.g., locally or externally) and selection of the appropriate file to upload.

Companion panel 222 is a media data block to which the operator can link an image (or another digital component, such as an HTML5 component). When one or more image media data items are linked to this companion panel, they are provided for display while the audio digital component is being played (as further described with reference to FIG. 2E).

The operator can edit multiple aspects of the template by clicking on the “Edit Template” button 224. These aspects are described below with reference to FIGS. 2B-2E.

FIG. 2B shows an example user interface that is displayed upon clicking the “Edit Template” button 224 (in FIG. 2A).

FIG. 2B (and the subsequent FIGS. 2C to 2H) include/s many of the same elements that were previously described with reference to FIG. 2A and thus, for brevity, the descriptions of those elements are not repeated here (although the same descriptions are equally applicable to these figures as well).

In this “Edit Template” mode, the operator can select any media data block in the swim lanes 206-210 and make edits to that asset as shown in the “Edit Asset” panel 228. Here, the operator has selected (e.g., by clicking on or selecting) the voice media data block 212. Thus, the “Edit Asset” panel 224 enables editing/adding to attributes of this selected asset, such as specifying whether this media data block is dynamic, providing a file for this asset, or adding one or more special effects for this asset.

By toggling the button 224, the operator can specify whether this media data block is dynamic or static. If the operator specifies that the media data block is dynamic, the operator indicates that any media item to be linked to this media data will vary across one or more variants of this audio digital component. On the other hand, if the operator specifies that the media data block is not dynamic (and thus, is static), the operator indicates that the media item to be linked to this media data will remain the same (and thus, be static) across copies/variants of this audio digital component.

As described above with reference to FIG. 2A, the operator can specify a voice file to link to this voice media data block 212 by dragging-and-dropping such a voice file or by clicking the upload button 230. The operator can further specify the special effects to be added to the media item to be linked to this media data block by selecting the dropdown arrow 226. Examples of special effects that can be added to the media data block include, but are not limited to, fading in or out of the audio data (e.g., as specified by the fade in and fade out times), trimming portions of the audio data (e.g., as specified by trim start and trim end times), and offset (which specifies, e.g., the amount time by which the particular media data item is to be offset from the beginning of the audio digital component or a preceding media data block).

By clicking/selecting the “Add track” button 224, the operator can add one or more additional swim lanes (corresponding to any of the media types: sound effects, voice, to which additional media data block/media data items can be added).

The operator can specify additional media data blocks to add to the template by clicking/selecting the + (plus) button 240 in any of the swim lanes 206-210 (as indicated in FIG. 2C). For example, by clicking the + (plus) button 240 in the voice swim lane 206, the operator requests the addition of another voice media data block to this lane.

FIG. 2C shows an example user interface that is displayed upon clicking the “Edit Template” button 224 and after the user has uploaded a media data item and selected the dropdown arrow 226.

As shown in FIG. 2C, the operator has uploaded a voice media data item named “Intro A.mp3” (labeled 234). If the operator decides to replace this media data item with another media data item, the operator can select the X 236 to delete this media data item and then upload another media data item as described with reference to FIGS. 2A and 2B.

As shown in this Figure, the operator can now interact with subpanel 232 to specify various effects, such as adding fades to the uploaded voice media item 234 and trimming the start or end of this media data item 234. The operator can also interact with subpanel 232 to add an offset, which specifies the amount of time from the beginning of the audio digital component that must elapse before this particular media data item is played. In this case, the operator has set an offset of 2.5 seconds (00:02:500), thus indicating that the voice media data item 234 should play 2.5 seconds after the start of playing of the audio digital component.

If the operator is satisfied with these settings, the operator can press the Apply button 238, which saves all the user’s configurations to this template. Alternatively, if the operator decides to continue editing the template, the operator need not press the Apply button 238.

FIG. 2D shows an example user interface in which an additional media data block 242 is added to the voice swim lane 206 upon the operator’s selection of the + (plus) button 240 in this swim lane. Once this media data block 242 is displayed in the voice swim lane 206, it becomes the “active” (i.e., currently editable) media data block and thus, the operator can make edits to this media data block/asset in the “Edit Asset” panel 228 in substantially the same manner as described above with reference to FIGS. 2A-2C.

FIG. 2E shows example user interfaces for adding/editing the companion panel 222.

The operator can indicate to edit the companion panel 222 by clicking/selecting the “Edit Companion” button 256. Upon clicking that button, the companion panel 222 becomes the “active” (i.e., currently editable) media data block and thus, the operator can make edits to this media data block in the “Edit companion” panel 250 (which is similar to the “Edit asset” panel 228 shown in FIGS. 2B-2D). Similar to FIG. 2B, the operator can specify, using button 260, whether the companion panel 222 will be dynamic or not (i.e., specifying whether the asset linked to this panel will vary across the multiple variants of the audio digital component). In addition, as shown in blocks 252 and 254, the operator can upload multiple media items for display in this media data block (i.e., companion panel 222) and can specify the sizes of each of these media data items as shown in block 252.

If the operator is satisfied with these settings for the template, the operator can press the Apply button 238, which saves all the user’s configurations to this template. Alternatively, if the operator decides to continue editing the template, the operator need not press the Apply button 238 and can edit the template in any manner described above with reference to FIGS. 2B-2E. The descriptions of FIGS. 2F-2H assumes that the operator saved his/her settings to the template by pressing the Apply button 238.

In some implementations, upon pressing the Apply button 238, the operator’s configurations to the base template are saved and provided to the template generator 114 (of FIG. 1). For example, the template interface 122 (within which the above configurations are made) generates a request to generate the template and this request includes a set of data that specifies the various configurations made to the base template by the operator. The template interface provides this request and the set of data to the template generator 114, which uses this data, to generate the template for the audio digital component (as further described with reference to FIG. 3).

Thus, using the interfaces in FIGS. 2A to 2E, the operator can specify at least one or more of the following attributes/settings for the template of the audio digital component: (1) the total duration of the audio digital component; (2) addition of a first set of media data blocks, (3) an addition of a media data block to be played after another media data block is scheduled to cease playing or being displayed, (4) special effects to add to a media data item linked to a media data block, (5) an adjustment to the time interval during which a media item for a respective media data block is to be played or displayed, (6) an identification (or change to the identification) that specifies whether the media data block includes static content or dynamic content, or (7) a removal and/or replacement of a media data item associated with a media data block with another media data item.

FIG. 2F shows the variant interface 124, which is displayed upon the operator pressing the Apply button 238 (as shown in, e.g., FIG. 2E) that saves the operator’s settings to the template. This variant interface 124 shows all the media data blocks of Variant 1 (which is simply an instance of the generated template) and the corresponding media data items and settings for these blocks, as selected by the operator (as described in FIGS. 2B-2E).

FIG. 2G shows an example variant interface 124 in which an operator can specify the number of copies/variants of the template for an audio digital component to be created. As shown, the operator can specify creation of a variant/copy of the template by clicking the “Make Copy” button 262. Upon clicking this button, a new variant (Variant 1 (copy)) is shown, which includes the same settings and configurations as Variant 1. Each time the operator selects the “Make Copy” button 262, a new variant is created. The operator can delete any created variants by selecting the checkmark button (e.g., buttons 266, 268) on that variant and then pressing the “Delete” button 264.

If an operator wants to make updates to a particular variant, e.g., “Variant 1 (copy)”, the operator can select the checkmark button 266 for that variant, which activates (i.e., makes it editable). Once activated, the operator can make additions or changes to the settings/configurations of this variant (similar to the settings/configurations described in FIGS. 2B-2E). For example, the operator can (1) add/remove media data blocks for this variant, (2) adjust the times at which media data items linked to the various media data blocks are played/presented, and (3) specify additional media data items to the dynamic media data blocks.

If the operator is satisfied with its settings/configurations for a particular variant, the operator can press the Save button 270, which saves all the user’s configurations to this variant. Alternatively, if the operator decides to continue editing the variant, the operator need not press the Save button 270 and can edit the variant in any manner described above with reference to FIGS. 2B-2E.

FIG. 2H shows another example variant interface 124 in which an operator can specify the number of copy/variant of the template for an audio digital component to be created. Unlike the variant interface in FIG. 2G, which provides a tile view of the various variants and their respective settings/configurations, the variant interface of FIG. 2H shows a list view of the various variants and their respective settings/configurations. As with the interface in FIG. 2G, the operator can perform the same actions on this interface in FIG. 2H.

In addition, via this variant interface, an operator can use a bulk upload/batch upload feature to quickly specify media data items to link to the various dynamic media data block. To do this, the operator uses a batch upload button (not shown) to launch a batch uploader, which generates a request to upload media data items via a batch upload. In response to this request, the variant manger 118 provides a batch uploader interface, via which a batch file can be uploaded. This batch file (1) identifies the media data items, (2) identifies resource locations of the media data items, and (3) includes a mapping between each media data item and a respective dynamic media data block in the plurality of variants. The batch file and the included settings/configurations are then provided/received by the variant manager 116, which then updates the various variants based on these settings (as further described with reference to FIG. 3).

FIG. 3 is a flow diagram of an example process 300 for generating and distributing variants of an audio digital component based on a template generated for the audio digital component. Operations of process 300 are described below as being performed by the components of the system described and depicted in FIGS. 1 and 2. Operations of the process 300 are described below for illustration purposes only. Operations of the process 300 can be performed by any appropriate device or system, e.g., any appropriate data processing apparatus. Operations of the process 300 can also be implemented as instructions stored on a computer readable medium, for example a non-transitory computer-readable medium. Execution of the instructions cause one or more data processing apparatus to perform operations of the process 300.

A request to generate a template for an audio digital component is received (at 305). In some implementations, a user interacts with the template interface 122 (which is a user-configurable interface) and specifies configurations/settings to the base template via this template interface 122 (as described with reference to FIGS. 2B-2E). The template interface 122 generates a request for generating a template for the audio digital component that includes a set of data that includes/represents the user configurations to the template. This set of data can include/represent data specifying, e.g., (1) media data blocks for inclusion in the audio digital component, (2) a total duration of the audio digital component, (3) a time interval in the total duration when a media item linked to a media data block is to be played or displayed, or (4) whether a media data block includes static or dynamic content.

In some implementations, the template interface 122 provides this request (including the set of data) to the template generator 114, and the template generator 114 receives this request from the template interface 122.

Based on the set of data included in the request and for each media data block, the template generator 114 determines whether the media data block includes static or dynamic content (310). In some implementations, for each media data block specified in the operation 305, the template generator 114 determines whether the media data block includes static or dynamic content using the user’s configuration in the set of data that specifies whether the media data block includes static or dynamic content. For example, if the user configuration specifies that a particular media data block includes static content, the template generator 114 determines that the particular media data block includes static content. As another example, if the user configuration specifies that a particular media data block includes dynamic content, the template generator 114 determines that the particular media data block includes dynamic content.

In response to receiving the request and determining whether the media data blocks include static or dynamic content, the template generator 114 generates the template for the audio digital component (315). In some implementations, the template generator 114 uses the set of data included in the request to generate the template for the audio digital component. For example, if the user configurations specify creating a certain number of media data blocks of varying media types (e.g., image, sound effects, music, voice), the template generator 114 creates a template including those specified media data blocks. In addition, using the total duration specified in the configurations, the template generator 114 updates the template to be of the time length/duration specified in the configurations. In addition, using the time intervals configurations that specify when each media data block is to be played/presented, the template generator 114 updates the template to adjust the start and end times of each media data block during the total duration. In addition, using the template generator 114′s determination as to whether a particular media data block includes static or dynamic content, the template generator 114 generates a dynamic or static media data block for inclusion in the template.

The template generator 114 links a first set of media items to media data blocks in the template that are identified as including static content (320). In some implementations, after or during creating the template, an operator can also specify media items to be linked to one or more static media data blocks (as described with reference to FIG. 2). Using the operator specification of media items to be linked to one or more static media data blocks, the template generator 114 links these media data items to their respective static media data blocks in the template.

Based on the template, the variant manger 116 generates multiple variants of the audio digital component (325). In some implementation, an operator specifies, e.g., via the variant interface 124, creation of multiple variants of the template (as described with reference to FIGS. 2F-2H). Based on the operator’s specifications, the variant manager 116 generates the specified number of variants/copies of the template. In creating each variant, the variant manager 116 automatically links, for each variant, the first set of media items with their respective static media data blocks in the variant. Thus, using the template-based approach, the variant manager 116 simply has to create a digital copy of a variant rather than receive the settings/configurations for each new version of the audio digital component and then generate a separate version of the audio digital component based on the received settings/configurations.

For each variant of the audio digital component, the variant manager 116 links a second set of media data items to media data blocks in the variant that are identified as including dynamic content (at 330). In some implementations, for each variant, an operator can identify, via variant interface 124, a second set of media data items to be linked to dynamic media data blocks in that variant (as described with reference to FIGS. 2F-2H). If the operator uses a batch upload operation (as described with reference to FIG. 2G), the variant manager 116 receives, via the variants interface 124, a batch file that (1) identifies the media data items, (2) identifies resource locations of the media data items, and (3) includes a mapping between each media data item and a respective media data block in the plurality of variants. Using this batch file, the variant manager 116 (1) obtains the identified media data items (from the resource locations identified in the batch file) and stores these media data items in the media items storage device 130, and (2) links the identified media data items in the batch file to the various dynamic media data blocks in the multiple variants. The variant manager 118 stores the variants and their respective attributes (e.g., media data blocks, media items linked to these media data blocks, time intervals during which each media data block is to be played or presented) in the variants storage device 128.

A request for a digital component is received from a client device (at 335). In some implementations, a client device 102, while navigating to a content platform 106, generates a request for a digital component, which is routed to the content provider 108. Upon receiving this request for a digital component, the content provider 108 can determine (e.g., based on contextual information such as device location, device content viewing history, device content preferences) to provide the audio digital component that was created in operations 305 to 330.

The content provider 108 determines or obtains a set of signals representing a context within which the request for the digital component is made by the client device (at 340). In some implementations, a script executing on a content page from where the request (in operation 335) is generated may collect data for a set of signals that represent the context within which the request for the digital component is received. The set of signals can include any data/signals that is obtained based on the device environment and a profile corresponding to the device. For example, the set of signals can include: (1) a location of the requesting the client device; (2) weather at the location of the requesting the client device; (3) a date when the request for the audio digital component was received; (4) a time when the request for the audio digital component was received; (5) a genre of music or other content previously played or viewed by the client device; (6) a profile corresponding to the client device 102 that specifies content preferences and/or prior consumed content; (7) a specified duration of the requested audio digital component; and/or (8) a specified size(s) of the image (or other digital component) corresponding to the companion panel.

Based on the set of signals representing the context, rules engine 116 provides for display on the client device 102, a particular variant of the audio digital component from among the plurality of variants (at 345). In some implementations, the rules engine 116 receives, via a user interface (e.g., a rules interface 126) and for each variant among the plurality of variants, a set of rules that define conditions specifying when the variant is to be provided for display to a requesting client device. In some implementations, the set of rules can specify one or more of the following: a location of the requesting the client device; weather at the location of the requesting the client device; a date when the request for the audio digital component was received; a time when the request for the audio digital component was received; or a genre of music previously played by the client device. Upon receiving the specification of the set of rules for each variant, the rules engine 116 generates the set of rules for each variant and stores each set of rules for a respective variant in the rules storage device 132.

For example, assume that four versions of the audio digital component relate to independence day attire. A set of rules for one of those variants may specify providing that variant only when: (1) the requesting client device is located in New York, (2) the request is made on dates in the range of July 3 to July 5, and (3) a genre of music previously played by the device includes patriotic songs.

Using the set of signals received at operation 340, the rules engine 116 determines whether the set of signals match any of the sets of signals corresponding to the plurality of variants (as stored in the rules storage device 132). The rules engine 116 determines a match exists by comparing the set of signals with each set of rules corresponding to the different variants.

In some implementations, this match could be an exact match between the set of signals and the conditions specified in the set of rules. In the above example, the rules engine 116 would determine that a match has been found when the set of signals indicate that the client device is in New York, the request was made on July 4, and the client device previously played patriotic music.

In some implementations, this match could be an approximate match between the set of signals and the set of rules, such that there only needs to be an exact match between some of the signals and the conditions specified in the rules corresponding to those signals (e.g., a majority of the signals and the corresponding rules, a certain threshold number of signals and the corresponding rules). In the above example, a match could be found if the client device is in New York and the request was made on July 4 (but the device previously did not play patriotic music as required by one of the rules).

In some implementations, this match could be a fuzzy match between the set of signals and the set of rules, such that the signals only have to be proximate to the expected values in the corresponding set of rules. In the above example, a match could be found if the client device is in Connecticut (proximate to New York) and the request was made on July 2 (proximate to the expected range of July 3 to July 5).

In some implementations, the rules engine 116 can use any of the above-described matching techniques (or other appropriate matching techniques) or any combination of the above-described matching techniques (or other appropriate matching techniques).

In response to determining that the set of signals matches a particular set of signals corresponding to a particular variant, the rules engine 116 determines that the variant corresponding to the matching set of rules is to be provided for display. In response to determining that the variant corresponding to the matching set of rules is to be provided for display, the rules engine 116 provides this particular variant, over network 104, for display on the requesting client device 102.

The requesting client device 102 receives the provided variant of the audio digital component and presents/displays this audio digital component on the content platform 108.

In this manner, the techniques described in this specification enable generation of multiple variants/iterations of a particular audio digital component and then only providing a particular variant for displaying/playing based on the context within which the request for content/audio digital component was made.

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, via a user interface, a request to generate a template for an audio digital component, the request including a set of data, wherein the set of data includes data specifying media data blocks for inclusion in the audio digital component, wherein each media data block (1) is a container for a media data item and (2) is of a particular media type;
determining, based on the set of data included in the request and for each media data block, whether the media data block includes static or dynamic content, wherein a media data block includes (1) static content when a media data item linked to the media data block remains unchanged in variants of the audio digital component or (2) dynamic content when a media data item linked to the media data block changes in one or more variants of the audio digital component;
in response to receiving the request and determining whether the media data blocks include static or dynamic content, generating the template for the audio digital component;
linking a first set of media data items to media data blocks in the template that are identified as including static content;
generating, based on the template, a plurality of variants of the audio digital component, including, for each variant, automatically linking the first set of media data items with media data blocks in the variant that are identified as including static content;
for each variant of the audio digital component, linking a second set of media data items to media data blocks in the variant that are identified as including dynamic content;
receiving, from a client device, a request for the audio digital component;
obtaining a set of signals representing a context within which the request for the audio digital component is made by the client device; and
providing for display, to the client device and based on the set of signals representing the context, a particular variant of the audio digital component from among the plurality of variants.

2. The computer-implemented method of claim 1, wherein the user interface is a configurable user interface,
the method further comprising detecting, via the configurable user interface, configurations by a user to a base template;
wherein receiving the request to generate the template for the audio digital component that specifies the set of data comprises:
in response to detecting the configurations by the user to the base template, receiving the request to generate the template for the audio digital component, wherein data included in the request is based on the configurations by the user.

3. The computer implemented method of claim 1, further comprising:
receiving, via the user interface and for each variant among the plurality of variants, a set of rules that define conditions specifying when the variant is to be provided for display to a requesting client device.

4. The computer-implemented method of claim 3, further comprising:
providing for display, to the client device and based on an evaluation of the set of signals and each set of rules, a particular variant of the audio digital component, including:
determining whether the set of signals match any of the sets of rules corresponding to the plurality of variants; and
in response to determining that the set of signals match a particular set of rules corresponding to a particular variant, providing the particular variant for display to the client device.

5. The computer implemented method of claim 3, wherein the set of rules specify one or more of the following:
a location of the requesting client device;
weather at the location of the requesting client device;
a date when the request for the audio digital component was received;
a time when the request for the audio digital component was received; or
a genre of music previously played by the client device.

6. The computer implemented method of claim 2, further comprising:
receiving modifications to the template for the audio digital components, wherein the modifications are generated based on interactions with the configurable user interface, wherein the interactions specify one or more of the following:
a change to the total duration of the audio digital component;
an addition of a media data block to be played after a time interval when another media data block is scheduled to cease playing or being displayed;
a special effect to add to a media data item provided within a media data block;
an adjustment to the time interval during which a media item for a respective media data block is to be played or displayed;
a change to the identification that specifies whether the media data block includes static content or dynamic content; or
a replacement of a media data item associated with a media data block with another media data item.

7. The computer implemented method of claim 1, further comprising obtaining, via the user interface, the first set of media data items and each of the second set of media data items, including:
receiving a request to upload media data items via a batch upload operation;
providing a user interface for performing the batch upload operation; and
receiving, via the user interface for performing the batch upload operation, a batch file that (1) identifies the media data items, (2) identifies resource locations of the media data items, and (3) includes a mapping between each media data item and a respective media data block in the plurality of variants.

8. The computer-implemented method of claim 1, wherein the set of data further includes:
a total duration of the audio digital component; and
a time interval in the total duration specifying when a media data item for each respective media data block is to be played or displayed.

9. A system, comprising:
one or more memory devices storing instructions; and
one or more data processing apparatus that are configured to interact with the one or more memory devices, and upon execution of the instructions, perform operations including:
receiving, via a user interface, a request to generate a template for an audio digital component, the request including a set of data, wherein the set of data includes data specifying media data blocks for inclusion in the audio digital component, wherein each media data block (1) is a container for a media data item and (2) is of a particular media type;
determining, based on the set of data included in the request and for each media data block, whether the media data block includes static or dynamic content, wherein a media data block includes (1) static content when a media data item linked to the media data block remains unchanged in variants of the audio digital component or (2) dynamic content when a media data item linked to the media data block changes in one or more variants of the audio digital component;
in response to receiving the request and determining whether the media data blocks include static or dynamic content, generating the template for the audio digital component;
linking a first set of media data items to media data blocks in the template that are identified as including static content;
generating, based on the template, a plurality of variants of the audio digital component, including, for each variant, automatically linking the first set of media data items with media data blocks in the variant that are identified as including static content;
for each variant of the audio digital component, linking a second set of media data items to media data blocks in the variant that are identified as including dynamic content;
receiving, from a client device, a request for the audio digital component;
obtaining a set of signals representing a context within which the request for the audio digital component is made by the client device; and
providing for display, to the client device and based on the set of signals representing the context, a particular variant of the audio digital component from among the plurality of variants.

10. The system of claim 9, wherein:
the user interface is a configurable user interface,
the one or more data processing apparatus are configured to perform operations further comprising further comprising detecting, via the configurable user interface, configurations by a user to a base template; and
wherein receiving the request to generate the template for the audio digital component that specifies the set of data comprises:
in response to detecting the configurations by the user to the base template, receiving the request to generate the template for the audio digital component, wherein data included in the request is based on the configurations by the user.

11. The system of claim 9, further comprising:
receiving, via the user interface and for each variant among the plurality of variants, a set of rules that define conditions specifying when the variant is to be provided for display to a requesting client device.

12. The system of claim 11, wherein the one or more data processing apparatus are configured to perform operations further comprising:
providing for display, to the client device and based on an evaluation of the set of signals and each set of rules, a particular variant of the audio digital component, including:
determining whether the set of signals match any of the sets of rules corresponding to the plurality of variants; and
in response to determining that the set of signals match a particular set of rules corresponding to a particular variant, providing the particular variant for display to the client device.

13. The system of claim 11, wherein the set of rules specify one or more of the following:
a location of the requesting the client device;
weather at the location of the requesting the client device;
a date when the request for the audio digital component was received;
a time when the request for the audio digital component was received; or
a genre of music previously played by the client device.

14. The system of claim 10, wherein the one or more data processing apparatus are configured to perform operations further comprising:
receiving modifications to the template for the audio digital components, wherein the modifications are generated based on interactions with the configurable user interface, wherein the interactions specify one or more of the following:
a change to the total duration of the audio digital component;
an addition of a media data block to be played after a time interval when another media data block is scheduled to cease playing or being displayed;
a special effect to add to a media data item provided within a media data block;
an adjustment to the time interval during which a media item for a respective media data block is to be played or displayed;
a change to the identification that specifies whether the media data block includes static content or dynamic content; or
a replacement of a media data item associated with a media data block with another media data item.

15. The system of claim 9, wherein the one or more data processing apparatus are configured to perform operations further comprising obtaining, via the user interface, the first set of media data items and each of the second set of media data items, including:
receiving a request to upload media data items via a batch upload operation;
providing a user interface for performing the batch upload operation; and
receiving, via the user interface for performing the batch upload operation, a batch file that (1) identifies the media data items, (2) identifies resource locations of the media data items, and (3) includes a mapping between each media data item and a respective media data block in the plurality of variants.

16. The system of claim 9, wherein the set of data further includes:
a total duration of the audio digital component; and
a time interval in the total duration specifying when a media data item for each respective media data block is to be played or displayed.

17. A non-transitory computer readable medium storing instructions that, when executed by one or more data processing apparatus, cause the one or more data processing apparatus to perform operations comprising:
receiving, via a user interface, a request to generate a template for an audio digital component, the request including a set of data, wherein the set of data includes data specifying media data blocks for inclusion in the audio digital component, wherein each media data block (1) is a container for a media data item and (2) is of a particular media type;
determining, based on the set of data included in the request and for each media data block, whether the media data block includes static or dynamic content, wherein a media data block includes (1) static content when a media data item linked to the media data block remains unchanged in variants of the audio digital component or (2) dynamic content when a media data item linked to the media data block changes in one or more variants of the audio digital component;
in response to receiving the request and determining whether the media data blocks include static or dynamic content, generating the template for the audio digital component;
linking a first set of media data items to media data blocks in the template that are identified as including static content;
generating, based on the template, a plurality of variants of the audio digital component, including, for each variant, automatically linking the first set of media data items with media data blocks in the variant that are identified as including static content;
for each variant of the audio digital component, linking a second set of media data items to media data blocks in the variant that are identified as including dynamic content;
receiving, from a client device, a request for the audio digital component;
obtaining a set of signals representing a context within which the request for the audio digital component is made by the client device; and
providing for display, to the client device and based on the set of signals representing the context, a particular variant of the audio digital component from among the plurality of variants.

18. The non-transitory computer readable medium of claim 17, wherein:
the user interface is a configurable user interface,
the instructions cause the one or more data processing apparatus to perform operations further comprising detecting, via the configurable user interface, configurations by a user to a base template; and
wherein receiving the request to generate the template for the audio digital component that specifies the set of data comprises:
in response to detecting the configurations by the user to the base template, receiving the request to generate the template for the audio digital component, wherein data included in the request is based on the configurations by the user.

19. The non-transitory computer readable medium of claim 17, further comprising:
receiving, via the user interface and for each variant among the plurality of variants, a set of rules that define conditions specifying when the variant is to be provided for display to a requesting client device.

20. The non-transitory computer readable medium of claim 17, wherein the instructions cause the one or more data processing apparatus to perform operations comprising:
providing for display, to the client device and based on an evaluation of the set of signals and each set of rules, a particular variant of the audio digital component, including:
determining whether the set of signals match any of the sets of rules corresponding to the plurality of variants; and
in response to determining that the set of signals match a particular set of rules corresponding to a particular variant, providing the particular variant for display to the client device.
